(19) United States
(12) Patent Application Publication
(10) Pub. No.: US 2004/0124700 A1
(43) Pub. Date: Jul. 1, 2004

(54) Method for controlling and/or regulating the build-up of brake pressure when full braking at a high friction coefficient

(76) Inventors: Steffen Luh, Hadamar (DE); Anthony Doller, Weiterstadt-Braunshard (DE)

Correspondence Address: Gerlinde M Nattler, Continental Teves, One Continental Drive, Auburn Hills, MI, 48326, US

(21) Appl. No.: 10/471,981

(22) PCT Filed: Feb. 27, 2002
(86) PCT No.: PCT/EP02/02058

(30) Foreign Application Priority Data
Mar. 15, 2001 (DE) 10112897.5
Apr. 4, 2001 (DE) 10116755.5

(51) Int. Cl. B60T 8/84

(52) U.S. Cl. 303/163

(57) ABSTRACT

The invention relates to a method for controlling or regulating the build-up of brake pressure when full braking at a high friction coefficient, which is provided for an independent brake system with anti-lock control and wherein the rotational behavior of the individual vehicle wheels and the instantaneous friction coefficient are determined and evaluated for the control and/or regulation of the brake pressure, said method comprising the following steps:

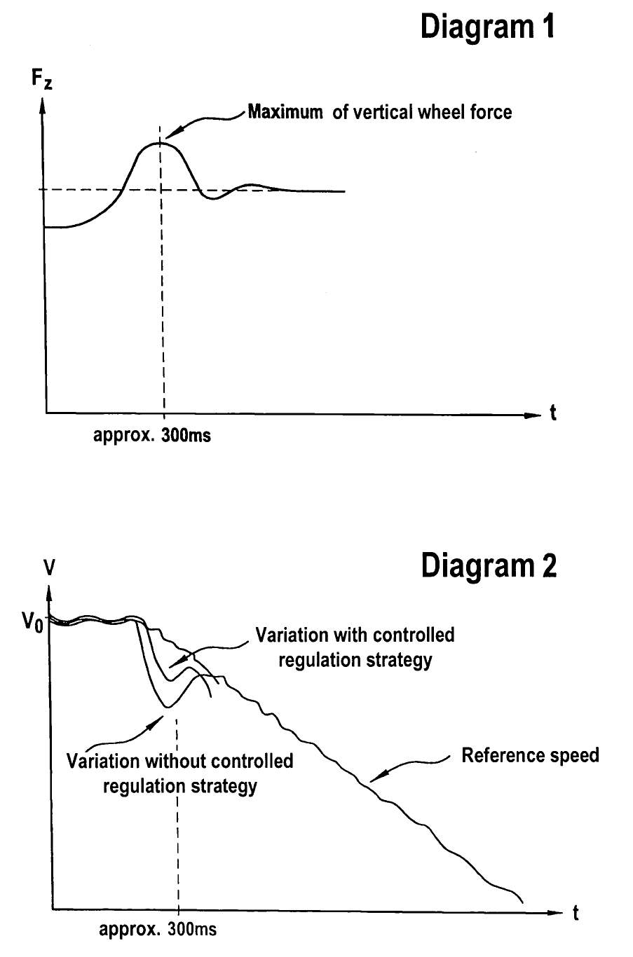

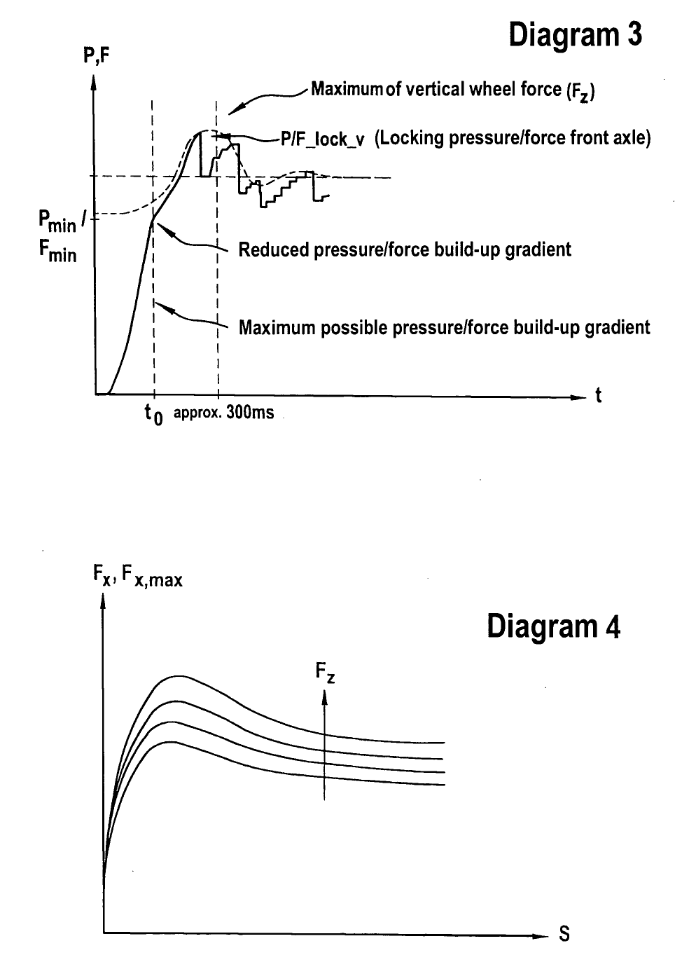

detecting a full braking or panic stop situation,

quick brake pressure build-up at the beginning of the braking operation,

comparing the wheel slip and the wheel deceleration or the filtered wheel deceleration with predetermined limit values, and

reduction of the brake pressure build-up gradient or transition to a reduced brake pressure build-up gradient directly before reaching the locking pressure level, that means, when the limit values predefined for the wheel slip and the wheel deceleration are exceeded.

These measures achieve a better utilization of the vertical wheel force that is increased by the dynamic axle-load transfer.

The present invention relates to a method for controlling and/or regulating the build-up of brake pressure when full braking at a high friction coefficient for an independent brake system with anti-lock control, wherein the rotational behavior of the individual vehicle wheels and the instantaneous friction coefficient and/or the roadway situation are determined or estimated and evaluated for the control and/or regulation of the brake pressure.

Future ‘X-By-Wire’ systems (Brake-By-Wire brake systems) such as electrohydraulic (EHB) or electromechanical brake systems (EMB), etc., are equipped with pressure and/or force sensors at the wheel brake circuits as required by the system. Data obtained by sensors of this type permits achieving pressure build-up profiles that are adapted better in comparison to the measured quantities and data available in conventional systems.

Especially the first pressure build-up, the entry into ABS control, and the regulation of the first tendency to wheel lock must be given particular attention. With up-to-date ABS controllers there is the frequent occurrence of high slip values being encountered on the individual wheels with the first brake application and, besides, a too long phase in the unstable range due to a delayed pressure reduction. The result is that the maximum of the vertical wheel force cannot always be utilized to achieve an increased brake force effect, and eventually valuable stopping distance is wasted.

In view of the above, an object of the present invention is to improve the pressure build-up strategy in systems of this type.

It has been found out that this object may be achieved by the method described in the attached claim 1, the special characteristics of said method being characterized by the sequence of the following steps:

detecting a full braking or panic stop situation,

quick brake pressure build-up at the beginning of the braking operation,

comparing the wheel slip and the wheel deceleration or the filtered wheel deceleration with predetermined limit values, and

reduction of the brake pressure build-up gradient or transition to a reduced brake pressure build-up gradient directly before reaching the locking pressure level, that means, when the limit values predefined for the wheel slip and the wheel deceleration are exceeded.

The sub claims relate to especially favorable embodiments of the method of the invention.

The accompanying drawings serve to illustrate and explain the invention in detail. In the diagrams of the drawings, Diagram 1 shows the variation of the vertical wheel forces.

Diagram 2 shows the variation of the wheel speeds and the vehicle reference speed.

Diagram 3 shows the pressure build-up strategy.

Diagram 4 shows the brake force as a function of the wheel slip with the vertical wheel force as a parameter.

The invention is based on the following knowledge and considerations:

The result of the great vehicle deceleration in an emergency braking is a considerable dynamic axle load transfer from the rear axle to the front axle. As this maneuver takes place with a rather pronounced and reproducible transient response, a remarkable increase in braking power may be gained with an optimized pressure control or pressure regulation.

The ‘X-By-Wire’ systems (Brake-By-Wire) or other systems capable of independent braking now render it possible to arrange for the first pressure build-up largely irrespective of the direct braking request from the driver.

This pressure build-up may be chosen so adeptly according to the outlines described hereinbelow that the above-mentioned dynamic axle load transfer of the vehicle is optimally taken into account.

It was found out in simulations and series of tests that a quick pressure build-up until attaining of the locking pressure (e.g. within only 100 ms) does not lead to optimal braking results because the vehicle has not yet completed the compression process. Normally, vehicles require roughly 300 ms until the maximum vertical force at the front wheels is reached.

The variation of the vertical wheel forces is illustrated in an exemplary situation in Diagram 1.

An excessively steep pressure build-up causes the front wheels to reach the wheel lock limit a considerable time before the maximum of the vertical wheel force is reached. Thus, pressure is reduced already at a very low pressure level because the locking pressure increases almost linearly to the vertical wheel force. The result is that the wheel is at a working point that is characterized by low vertical wheel forces and high slip values. Diagram 2 exhibits the variation of the wheel speeds in the conventional way and when implementing the method of the invention (that means with and without controlled regulation strategy).

The findings obtained imply that a quickest possible pressure build-up (so-called BA, or rather Brake Assistant function) must take place at the commencement of braking operations, without the front wheels being induced to lock already with the full pressure build-up gradient, i.e., a pressure rise at a reduced gradient should be brought about directly before the wheel lock pressure level is reached. This gradient is calculated depending on the wheel rotational behavior that is evaluated by means of the slip and the filtered wheel deceleration.

Attaining of the locking pressure level is detected by way of evaluating the averaged pressures on the front axle, slip assessment (e.g. >5% slip and a slip integral observation) and filtered wheel decelerations (e.g. <−1.6 g). Diagram 3 illustrates the strategy of the pressure/force build-up of the invention.

It is achieved that the vehicle weight has already transferred to the front axle to a large extent so that accordingly the wheel is operated at a working point characterized by a stable slip range with high vertical wheel forces. With an optimal timing the front wheels are caused to lock before the vertical wheel force reaches its maximum. It is advisable to strive for this condition because otherwise, with a later locking of the front wheels at the point of the maximum vertical wheel force, a strong regeneration feedback effect will occur, said effect showing itself in that the μ slip peak of the tire is exceeded exactly in this point when the maximum weight weighs on the tire. Thus, not only the peak is passed in the event of a now prevailing wheel lock but also the tire is transferred into a working range with a considerably lower amount of vertical wheel force to be transmitted (cf. Diagram 4). The resulting pronounced tendency of the tire to lock demands an extreme pressure relief and a hence encountered fluctuation of the longitudinal deceleration. Therefore, the control strategy demands a compromise ranging between the described extreme cases.

Hence, as can be taken from Diagram 3, the method of the invention permits reaching a delay of the brake pressure build-up as a consequence of the reduction of the brake pressure build-up gradient at the time to (to designates the transition to the reduced brake pressure build-up gradient) and the further variation of the brake pressure gradient in dependence on the wheel rotational behavior until the locking pressure level is reached—compared to a conventional anti-lock control. The increase of the vertical wheel force due to the dynamic axle load transfer takes effect at the point of time the anti-lock control is applied. The control-induced brake pressure reduction commences later, the locking pressure level is higher, and the stopping distance is thereby shortened.

For the rating of the dynamic axle load fluctuation during the first pitching motion of the vehicle owing to the new X-By-Wire pressure/force sensor technology, the following points should be considered:

The above-described pressure modulation mechanisms necessitate knowledge about the individual vertical wheel forces during the first pitching motion of the vehicle. Customary suspension systems start out from largely constant variations of the vertical wheel force when the vehicle is stopped vigorously at high coefficients of friction (hard brake apply).

The coefficient of friction of the roadway is identified by way of the pressure value reached without locking tendency.

The hard depression is identified by way of the gradient of the brake pedal applied by the driver by means of the brake pedal sensor technology (e.g. pedal travel, pedal pressure).

Summarizing, it should be noted:

The special features of the method of the invention are the utilization of the wheel pressure/force information in combination with a service brake system (X-By-Wire) capable of independent braking in connection with the pressure/force build-up strategy.

What is used is the dynamics of the existing service brake system that is capable of independent braking, upon application of the brake pedal or detection of an emergency situation (brake assistant intervention→full braking) at a high coefficient of friction, i.e., maximum build-up of nominal pressure or force at the beginning of the braking operation, then a variation of nominal pressure or nominal force that is adapted to the vehicle, weakened, defined, regulated (or controlled), with a view to optimally utilizing the vertical wheel force that rises to the maximum (see Diagram 1) without exposing the wheel to excessive slip and, eventually, wasting stopping distance thereby. The vertical wheel force is to be considered as a standard of the brake force that can be transmitted on the vehicle.

The adapted regulated/controlled variation of the brake force/brake pressure specification depends on:

a) the wheel behavior (slip→optimal slip band, the wheel deceleration),

b) the estimation of the friction coefficient of the roadway (integrating the wheel pressure information),

c) a possibly co-running vehicle model (fed by measuring signals of the chassis).

1. Method for controlling and/or regulating the build-up of brake pressure when full braking at a high friction coefficient for an independent brake system with anti-lock control, wherein the rotational behavior of the individual vehicle wheels and the instantaneous friction coefficient and/or the roadway situation are determined or estimated and evaluated for the control and/or regulation of the brake pressure, characterized by the following steps:
detecting a full braking or panic stop situation,
quick brake pressure build-up at the beginning of the braking operation,
comparing the wheel slip and the wheel deceleration or the filtered wheel deceleration with predetermined limit values, and
reduction of the brake pressure build-up gradient or transition to a reduced brake pressure build-up gradient directly before reaching the locking pressure level, that means, when the limit values predefined for the wheel slip and the wheel deceleration are exceeded.

2. Method as claimed in claim 1, characterized in that the brake pedal application speed and/or speed variation is evaluated for detecting the full braking or panic stop situation.

3. Method as claimed in claim 1 or 2, characterized in that a slip in the order of >3% up to >7%, in particular >5%, is predetermined as a limit value for the wheel slip.

4. Method as claimed in any one or more of claims 1 to 3, characterized in that a value in the order of ‘<1.2 g’ up to ‘<−2.5 g’, in particular ‘<−1.6 g’, is predetermined as a limit value for the filtered wheel deceleration.

5. Method as claimed in any one or more of claims 1 to 4, characterized in that the reduced brake pressure build-up gradient until the commencement of the anti-lock control, in dependence on the wheel behavior, in particular the wheel slip and the filtered wheel deceleration, is proportioned such that the predetermined limit values of the wheel slip and the filtered acceleration are approximately preserved, i.e., lie within a predetermined tolerance range.
